(19) United States
(12) Patent Application Publication
(10) Pub. No.: US 2006/0059798 A1
(43) Pub. Date: Mar. 23, 2006

(54) Rot resistant casing and method of making a rot restistant casing

(76) Inventor: Robert H. Young, Beaver Dam, KY (US)

Correspondence Address: BERENATO, WHITE & STAVISH, LLC, 6550 ROCK SPRING DRIVE, SUITE 240, BETHESDA, MD, 20817, US

(21) Appl. No.: 10/947,442

(22) Filed: Sep. 23, 2004

(51) Int. Cl. E06B 1/04

(52) U.S. Cl. 52/204.1; 52/205

(57) ABSTRACT

An wood rot resistant assembly comprises a vertical wooden member having an exposed end grain. At least two buttons extend from the end grain. A sill assembly defines a horizontal base plane. The sill assembly extends perpendicular to the vertical member. The buttons elevate the vertical member end grain above the horizontal base plane.

### FIELD OF THE INVENTION

This invention generally relates to a wooden casing, such as a door frame or window frame, that prevents wood rot when installed on a horizontal base, such as a concrete slab, where the base may be comprised of a porous material or subjected to moisture accumulation. The invention prevents the communication of moisture from the base to the casing because the casing is spaced above the base a distance exceeding the meniscus of water. The invention specifically relates to a design for a rot resistant wooden window or door frame. The invention also relates to a method of making a rot resistant casing.

### BACKGROUND OF THE INVENTION

Many wooden door and window frames provide no protection for the wooden surfaces that abut a floor or base. Consequently moisture may be “wicked up” from (or through) the floor or similar horizontal surface and into the associated wooden structure. Doorjamb end grains have proven to be particularly problematic because of their affinity for absorbing moisture. Should the moisture in the wood achieve a sufficiently high level, then the wood may eventually rot. Wood rot typically cannot be repaired in situ, thus necessitating the replacement of the door or window frame.

Several techniques and systems have been used address the problem associated with wood rot in door frames and other similar structures. One such system involves splicing a rot resistant material, such as plastic or plastic composite, with a wooden frame member to create a wooden door frame having a finger-joint connecting the wood and plastic components together. This method is relatively expensive and the spliced portion of the door frame may not accept paint or finish in the same manner as a wooden door frame, and consequently the finished door frame does not have a uniform finish and appearance.

The prior art also includes the use of an insulating strip across the door frame end grain, as shown in U.S. Pat. No. 6,161,343 to Young, entitled Wood Rot Preventing Wood Casing End Grain Moisture Barrier Assembly and Method, the inventor of which is also the inventor hereof. While this method is effective, it requires relatively precise placement of the insulating strip. Additionally, the applicant has found that most wood rot can be prevented by securing the frame to a sill in order to space the door frame or exposed end grain wood surface a distance from the floor or base that is greater than the meniscus of water. Precisely spacing a door frame relative to a sill in a large-scale production process is difficult and cost prohibitive.

The need exists for an effective and efficient assembly that is inexpensive to manufacture and effectively prevents wood rot. The disclosed invention provides an end grain assembly that incorporates at least two button-type components to precisely space a wooden casing such as door frame, window frame, brick mold or the like, above a horizontal surface and thereby prevent moisture from “wicking up” into the associated wooden casing. The “buttons” require less material and a less sophisticated manufacturing process than the prior art rot prevention methods, while still effectively preventing wood rot.

### SUMMARY OF THE INVENTION

The present invention is an assembly comprising a vertical wooden member with at least two buttons attached to the lower exposed end grain of the vertical member. The vertical member is attached to a sill assembly, which extends perpendicular to the vertical member. The sill assembly has a lower planar surface that defines a horizontal plane. The buttons elevate the vertical member above the horizontal plane defined by the planar lower surface of the sill assembly.

The present invention also comprises a door frame assembly that includes a vertically extending wooden door frame that is spaced above an essentially horizontal floor by two cylindrical buttons. The top of each button is attached to a doorjamb exposed end grain, and the bottom of each button abuts the floor. A doorsill assembly is secured to the doorjamb and extends normal to the doorjamb. The buttons elevate the doorjamb end grain above the floor and thereby prevent wood rot in the doorjamb.

The present invention also comprises a method of making a rot resistant assembly. The method comprises providing a vertical wooden member that has an end grain face. At least two buttons are attached to the end grain face. A frame assembly is created by connecting a sill assembly to the vertical member so that the bottom of the sill assembly is disposed in the same horizontal plane as the bottom of the buttons. The frame assembly is then installed on a horizontal surface so that the vertical member is elevated above the horizontal surface to a height greater than the meniscus of water, thereby preventing water from being drawn up from the horizontal surface and rotting the vertical member.

### BRIEF DESCRIPTION OF THE DRAWINGS

FIG. 1 is a fragmentary perspective view of a present invention.

FIG. 2 is a fragmentary cross-sectional view of the present invention taken along the line 2-2 in FIG. 1.

FIG. 3 is an elevational view of a doorjamb button.

FIG. 4 is an elevational view of a door and door frame in accordance with the present invention.

### DETAILED DESCRIPTION OF PREFERRED EMBODIMENTS

The present invention comprises a rot resistant casing 10, primarily designed for door and window frames. Specifically, the invention comprises a casing 10 that prevents communication of moisture from a floor or horizontal base upwardly into a wooden window or doorjamb 12. Although the rot-resistant casing shown in the drawings and described in the specification is generally applicable to a door frame, the invention also has application in other types of structures, and the scope of the invention is not limited to doors or windows.

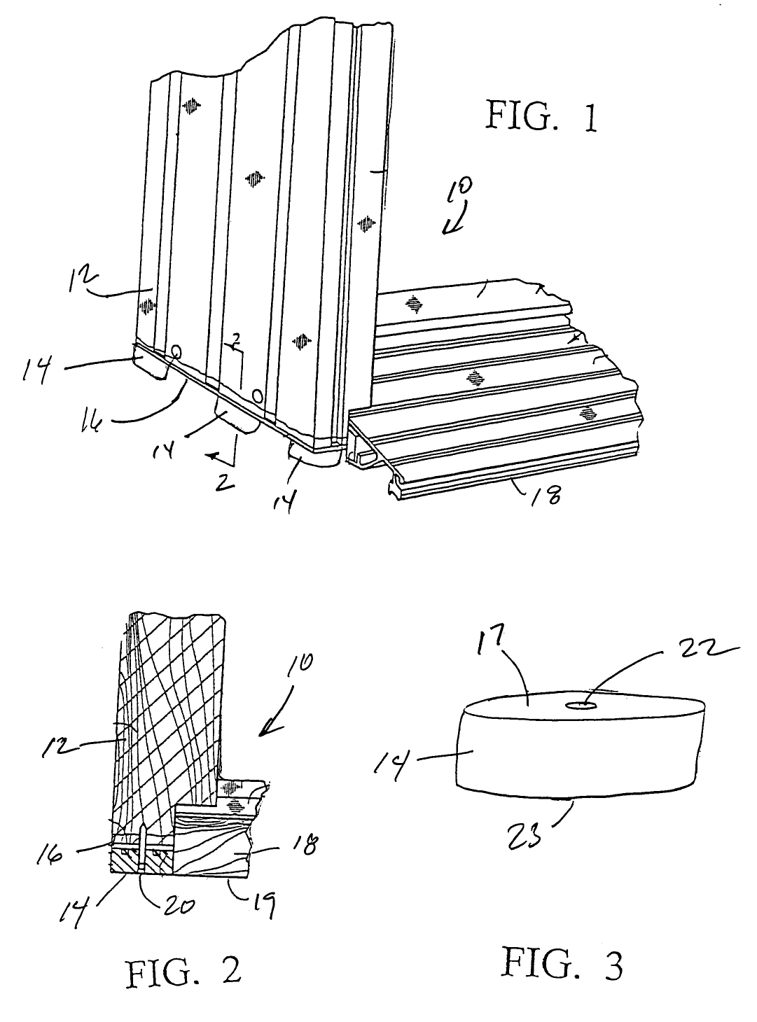

As best shown in FIG. 1, the rot-resistant casing 10 is comprised of a vertically extending wooden doorjamb 12 with at least two doorjamb “buttons” 14 attached to the exposed end grain 16 of the doorjamb 12. The doorjamb buttons 14 elevate the doorjamb 12 above a floor or horizontal surface to a height greater than the meniscus of water so that water is not “wicked-up” from the floor into the doorjamb 12. At least two buttons 14 should be used in order to prevent the doorjamb 12 from canting and thereby causing a portion of the doorjamb 12 to contact the floor or horizontal base. A doorsill 18 extends horizontally from the doorjamb 12. The exposed doorjamb end grain 16 may be coated with wax or finish to further seal the door frame and protect the exposed surfaces from moisture.

As best shown in FIG. 2, a tack 20 may be used to attach the top surface 17 of button 14 to the doorjamb end grain 16. Alternatively, the button 14 may be attached by a screw, nail, staple, adhesive, a different attachment component, or by any method known in the art consistent with the function of the button 14. The tack 20 may also be an integral part of the button 14, so that the tack 20 and button 14 comprise a single component. Button 14 are sometimes in the industry referred to as tack glides.

As best shown in FIG. 3, button 14 may have a cylindrical shape. Other shapes such as domes, squares, rectangles, diamonds, triangles, etc. should also be considered within the scope of the invention. In the preferred embodiment, the buttons 14 have a diameter that is less than the width of the end grain 16 of the doorjamb 12, so that the buttons 14 do not engage the doorsill 18. In an alternate embodiment, the buttons 14 may also have a diameter that is equal to the width of the end grain 16 and may abut the doorsill 18, as best shown in FIG. 2.

Although three buttons 14 are shown in FIG. 1, any number of buttons 14 should also be considered within the scope of the invention. Similarly, although the buttons 14 are shown as uniformly spaced along the end grain 16, the buttons 14 need not be evenly spaced and may be positioned as required for a specific application. Although the buttons 14 preferably are identical, the shape and properties of individual buttons 14 may be altered as required for a particular application.

The hole 22 shown in the button 14 in FIG. 3 is intended to accommodate a connector such as a tack 20, however the button 14 may be solid if another connecting method is used. The button 14 may also be hollow or perforated as required for a specific application. The preferred material of construction for the buttons 14 is plastic. Buttons 14 may be comprised of metal, fiberglass, or a composite material. The buttons 14 should be made from a material which does not wick water, so that the buttons 14 thereby do not inadvertently serve as a mechanism for communicating water to the exposed end grain 16.

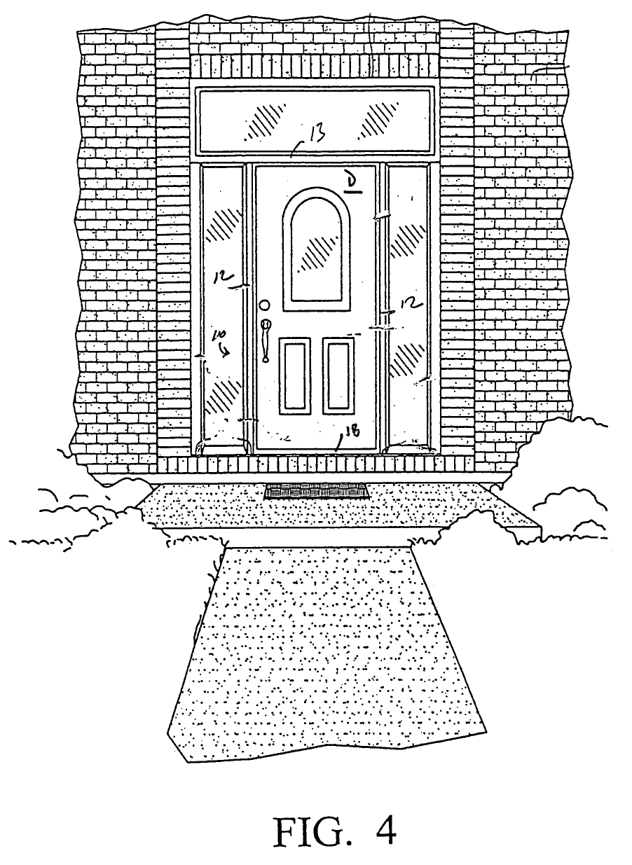

A method of making a rot-resistant assembly is also within the scope of the invention. The casing 10 is constructed by attaching at least two buttons 14 to the end grain portion 16 of a doorjamb 12. The casing 10 is connected to a doorsill 18 so that the bottom faces 23 of the buttons 14 are disposed on the same horizontal plane as the planar lower surface 19 of the doorsill 18, thereby creating a door frame assembly. The door frame assembly is installed on a horizontal surface so that the doorjamb 12 is elevated above the horizontal surface 19 to a height exceeding the meniscus of water, thereby preventing water from being drawn up from the horizontal surface and subsequently rotting the doorjamb 12. As best shown in FIG. 4, the assembled door frame includes casings 10, each providing one of the opposing door jambs 12, a header 13, and the doorsill 18. Door D may be conveniently attached to one of the jambs 12 by means known in the art.

For the foregoing reasons, it is clear that the present invention provides a rot-resistant assembly that addresses the problem of moisture migration from a horizontal base to an adjacent wooden member. The method and apparatus described above is effective as well as relatively inexpensive to construct.

The invention may be modified in multiple ways and applied in various technological applications. For example, the invention may be used with a garage door frame or in applications that do not include a doorsill 18. Although the materials of construction are described, they may include a variety of alternative compositions consistent with the function of the invention. Such variations are not to be regarded as a departure from the spirit and scope of the invention, and all such modifications as would be obvious to one skilled in the art are intended to be included within the scope of the following claims.

What is claimed is:

1. An assembly comprising:
a vertical wooden member having an exposed end grain,
at least two buttons extending from said end grain, and,
a sill assembly defining a horizontal base plane, said sill assembly extending perpendicular to said vertical member, said buttons elevating said vertical member end grain above said horizontal base plane.

2. The assembly of claim 1 wherein said horizontal base plane is coincident with a floor.

3. The assembly of claim 1 wherein said vertical member is elevated above said horizontal base plane at least a distance exceeding the meniscus of water.

4. The assembly of claim 1 wherein said buttons are formed from a material selected from a group consisting of plastic, metal, fiberglass, and composite material.

5. The assembly of claim 1 wherein the diameter of said buttons is less than a width of said vertical member end grain.

6. The assembly of claim 1 wherein the diameter of each of said buttons is equal to a width of said vertical member end grain.

7. The assembly of claim 1 wherein said buttons are positioned adjacent opposite ends of said vertical member end grain.

8. The assembly of claim 1 wherein each of said buttons is secured to said vertical member end grain by a tack.

9. The assembly of claim 1 wherein each of said buttons is separate from and does not abut said sill.

10. The assembly of claim 1 wherein each of said buttons has a cylindrical shape.

11. The assembly of claim 1 wherein said assembly comprises first, second and third buttons.

12. The assembly of claim 1 wherein said first, second, and third buttons are evenly spaced.

13. The assembly of claim 12 wherein said first button is positioned adjacent a first end of said vertical member end grain, said second button is positioned adjacent a second end of said vertical member end grain, and said third button is positioned intermediate said first and said second buttons.

14. The assembly of claim 1 wherein said sill member is a doorsill.

15. The assembly of claim 1 wherein said vertical member is a doorjamb.

16. The assembly of claim 1 further comprising a header, wherein said assembly in combination with said header comprises a door frame assembly.

17. The assembly of claim 1 wherein each of said buttons has a shape selected from the group consisting of irregular shapes, cylinders, domes, squares, rectangles, diamonds, and triangles.

18. The assembly of claim 1 wherein said vertical member has a one of a wax or a sealant applied to said end grain.

19. A door frame assembly comprising:
two vertically extending wooden doorjambs, each of said doorjambs having an exposed end grain,
a header attached to and extending between upper portions of said doorjambs,
a doorsill assembly attached to and extending between lower portions of said doorjambs, said doorsill assembly extending normal to said doorjambs,
at least two cylindrical buttons attached to each of said end grain, a bottom side of said buttons being positioned in a same horizontal plane as a bottom side of said doorsill,
wherein said buttons elevate said doorjamb exposed end grain above the plane a distance exceeding the meniscus of water and thereby prevent wood rot in said doorjamb exposed end grain.

20. A method of making a rot resistant assembly comprising:
providing a vertical member having an end grain face,
attaching at least two buttons to the end grain face,
connecting the vertical member to a sill assembly so that a lower side of the sill assembly is disposed in a same horizontal plane as a bottom of the buttons and thereby creating a frame assembly, and
installing the frame assembly on a horizontal surface so that the vertical member is elevated above the horizontal surface to a height greater than the meniscus of water, thereby preventing water from being drawn up from the horizontal surface and rotting the vertical member.
